(19) United States
(12) Patent Application Publication
(10) Pub. No.: US 2004/0090802 A1
(43) Pub. Date: May 13, 2004

(54) Noise suppression in switching power supplies

(75) Inventors: Behrouz Pourseyed, Vancouver (CA); Trong Hoang, Vancouver (CA)

Correspondence Address: Robert E. Krebs, Esq., THELEN REID & PRIEST LLP, P.O. Box 640640, San Jose, CA, 95164-0640, US

(73) Assignee: Sierra Wireless, Inc., a Canadian Corporation

(21) Appl. No.: 10/285,980

(22) Filed: Nov. 1, 2002

(51) Int. Cl. H02J 1/02

(52) U.S. Cl. 363/39

(57) ABSTRACT

A method and apparatus for suppressing noise caused by the switching of a switching power supply. The method and apparatus use frequency dithering techniques to distribute the switching noise and its spurious products over a wider bandwidth, thereby reducing the average peak power per given range of bandwidth. The frequency dithering techniques are particularly applicable to mobile radio applications, where switching noise from switching power supplies can modulate the transmit carrier and its harmonics, sub-harmonics and intermediate frequency products.

### FIELD OF THE INVENTION

The present invention relates in general to power supplies. More particularly, the present invention relates to suppressing noise in a switching power supply.

### BACKGROUND OF THE INVENTION

Switching power supplies are known for their ability to efficiently convert a direct current (DC) supply voltage to a DC output voltage having a different voltage level. They are often used in applications where compatibility with different power sources is required. Switching power supplies are also becoming more widespread in mobile radio communications systems. For example, PCMCIA (Personal computer memory card international association) type radio devices operate through a mobile host device, such as laptop computer or a personal digital assistant (PDA), to allow wireless communications through the host device. The host device provides a voltage within a range of 3.3 to 5 volts to the PCMCIA peripheral. This voltage is then either up-converted (e.g. to 5 volts), using a boost switching power supply or down-converted (e.g. to 3 volts), using a buck switching power supply.

A drawback relating to the use of a switching power supply in radio communications systems, however, is that the switching power supply inherently generates noise, by virtue of its switching action. This noise can interfere with other parts of the radio communications system, for example by modulating the transmit carrier and its harmonics, sub-harmonics and intermediate frequency products. This unwanted modulation presents itself in the form of broadband spurious transmissions (i.e. “spurs”) inside and outside the transmit and receive frequency bands. These spurs not only interfere with the radio communication, they can also render the system noncompliant to wireless standards, such as the GSM (Global System for Mobile Communications) standard. Document GSM05.05, section 4.3.3.2 of the GSM standard collectively specifies spurious transmissions (whether modulated or unmodulated) and switching transients by measuring the peak power in a given bandwidth at various frequencies. To facilitate the design of the wireless system, section 13 in document GSM11.10 of the GSM standard sets forth specific permissible exceptions. However, these exceptions can be easily exhausted by the spurs generated by the switching power supply.

### SUMMARY OF THE INVENTION

Generally, the present invention is directed at methods and apparatuses for switching power supply noise suppression using frequency dithering techniques. The methods and apparatuses are particularly applicable to applications where a switching power supply is used in a mobile communications system.

According to one aspect of the invention, a switching power supply having noise suppression capabilities includes a switching regulator having a direct current (DC) voltage input, an oscillator input and a regulator output; a filter having a first end coupled to the output of the switching regulator and a second end providing an output for the power supply; a variable-frequency oscillator coupled to the oscillator input of the switching regulator; and an alternating waveform generator coupled to the frequency control input of the variable-frequency oscillator. The variable-frequency oscillator has a frequency control input and an output that provides a variable-frequency oscillating signal.

According to another aspect of the invention, a switching power supply having noise suppression capabilities includes a switching regulator having a direct current (DC) voltage input, an oscillator input and an output; a filter having a first end coupled to the output of the switching regulator and a second end providing an output for the power supply; a variable-frequency oscillator coupled to the oscillator input of the switching regulator, said variable-frequency oscillator having a frequency control input and an output that provides a variable-frequency oscillating signal; a pseudorandom number generator that provides a pseudorandom sequence of digital bits; a digital-to-analog converter configured to accept the pseudorandom sequence of digital bits and provide a control signal having a variable voltage; and a voltage controlled oscillator having a frequency control input configured to accept the control signal and an output that provides the variable-frequency oscillating signal.

According to yet another aspect of the present invention, a method of reducing noise in a switching power supply includes the steps of converting a direct current (DC) input voltage to a DC output voltage using a switching power supply, and varying the rate at which the switching power supply switches during the step of converting. The step of varying the rate at which the switching power supply switches may include varying a voltage level of a control signal at a control input of a voltage controlled oscillator (VCO) to provide a pulse width modulator oscillating signal determinative of the rate of switching. Varying the voltage level may be done in many different ways. For example, it may be accomplished by providing a digital-to-analog converted sequence of pseudorandom bits to the control input of the VCO or may, for example, be accomplished by providing an alternating signal to the control input of the VCO.

Other aspects of the invention are described and claimed below, and a further understanding of the nature and advantages of the inventions may be realized by reference to the remaining portions of the specification and the attached drawings.

### BRIEF DESCRIPTION OF THE DRAWINGS

FIG. 1 shows a schematic diagram of a switching power supply that includes a frequency shift keying (FSK) oscillator, for suppressing switching noise, according to an embodiment of the present invention;

FIG. 2 shows a switching power supply that includes a frequency shift keying (FSK) voltage controlled oscillator (VCO), for suppressing switching noise, according to another embodiment of the present invention;

FIG. 3 shows a switching power supply that includes a linearly modulated voltage controlled oscillator (VCO), for suppressing switching noise, according to another embodiment of the present invention;

FIG. 4 shows a switching power supply that includes a spread-spectrum oscillator, for suppressing switching noise, according to another embodiment of the present invention;

FIG. 5 shows a spectrum analyzer screen capture of a portion of a receiver band of a receiver in a wireless communications system, while an associated transmitter is transmitting and is affected by the switching action of a nearby switching power supply not having any noise suppression apparatus; and

FIG. 6 shows a spectrum analyzer screen capture of a portion of a receiver band of a receiver in the same wireless communications system described in association with FIG. 5, except where the nearby switching power supply includes the frequency dithering noise reduction methods and apparatus described in accordance with embodiments of the present invention.

### DETAILED DESCRIPTION OF THE INVENTION

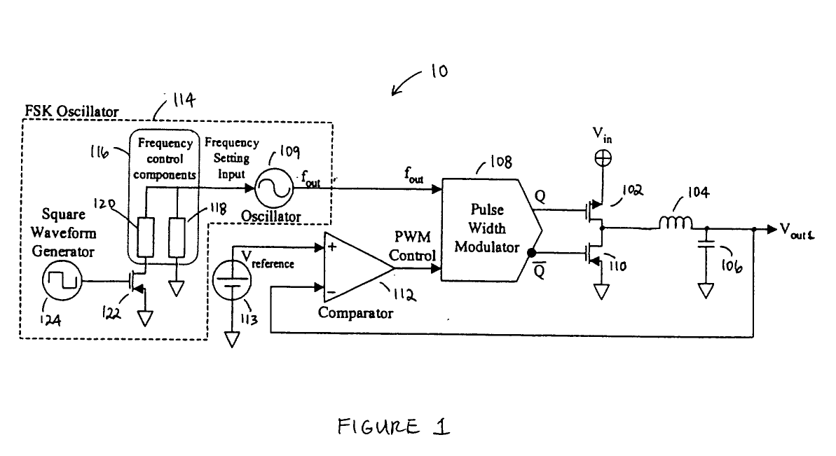

A schematic diagram of a power supply 10 having switching noise suppression capabilities, according to an embodiment of the present invention, is shown in FIG. 1. A DC input voltage Vin is coupled to the source of an n-channel metal-oxide-semiconductor field effect transistor (MOSFET) 102. This input voltage Vin is intermittently coupled to an LC filter, comprised of an inductor 104 and a capacitor 106, by control of a pulse width modulator (PWM) 108. PWM 108 has an input configured to accept an oscillating signal f_{OUT} from an oscillator 109 and an output Q, which provides a square wave signal having a duty cycle (i.e. ratio of high time to signal period) that determines the DC voltage level at output Vout. The square wave signal is coupled to the gate of MOSFET 102, which is on when the square wave signal is high and off when the square wave signal is low. During the time MOSFET 102 is on, the input voltage Vin is coupled to the LC filter and a voltage is induced across inductor 104. When the square wave signal drops from high to low, MOSFET 102 turns off and a p-channel MOSFET 110 turns on. When MOSFET 110 is on, inductor 104 discharges its energy through a load (not shown in FIG. 1), which is coupled to the output Vout. A comparator 112 constantly compares a sample of the voltage at output Vout to a reference voltage 113 and provides a PWM control signal (i.e. an error voltage) to another input of the PWM 108. PWM control signal is used by PWM 108 to adjust the duty cycle of the square wave signal at outputs Q and \overline{Q}.

Some or all of the above-described components may be integrated in a single integrated circuit. In one particular embodiment, the MOSFET switches 102 and 110, PWM 108 and comparator 112 comprise a switching regulator, which may be integrated with oscillator 109 in an integrated circuit, and the other components are coupled to input/output pins of the integrated circuit.

Switching power supply 10 also includes a frequency shift keying (FSK) oscillator 114, which includes oscillator 109. In this exemplary embodiment, oscillator 109 provides an oscillating signal f_{OUT} having a frequency dependent upon the total resistance of the frequency control components 116 coupled to the frequency setting input of oscillator 109. The frequency control components 116 are shown in FIG. 1 as comprising two resistors 118 and 120. First resistor 118 has a first end coupled to the frequency setting input of oscillator 109 and a second end coupled to ground. Second resistor 120 has a first end coupled to the frequency setting input of oscillator 109 and a second end coupled to an electronic switch 122 such as for example, a p-channel MOSFET. A square wave signal, applied to the gate of MOSFET 122 from square waveform generator 124, is used to alternately couple and decouple the second resistor 120 from a parallel connection to first resistor 118. More specifically, when the square wave signal from square waveform generator 124 is low, second resistor 120 and first resistor 118 are coupled in parallel, and, when the square wave signal from square waveform generator 124 is high, second resistor is decoupled from first resistor 118. So, when the square wave signal from square waveform generator 124 is low, the parallel combination of first and second resistors 118 and 120 is coupled to the frequency setting input of oscillator 109, and, when the square wave signal from square waveform generator 124 is high, only first resistor 118 is coupled to the frequency setting input of oscillator 109.

The square wave signal from square waveform generator 124 switches MOSFET 122 on and off as the power supply 10 converts the input DC voltage Vin. Accordingly, the frequency of oscillating signal f_{OUT} changes from a first frequency to a second frequency, as the total resistance varies between the parallel combination of first resistor 118 and second resistor 120 and the resistance of first resistor 118 alone. PWM 108 responds to the different frequency signals by providing corresponding first and second square wave signals at PWM outputs Q and \overline{Q}. The different frequency square wave signals provided at outputs Q and \overline{Q} causes the MOSFET switches 102 and 110 of the switching power supply 10 to switch at a first frequency half the time and a second frequency the other half of time. This frequency dithering operation of switching power supply 10 creates a lower average peak power per given bandwidth, so that power supply 10 more readily complies with noise limitation standards.

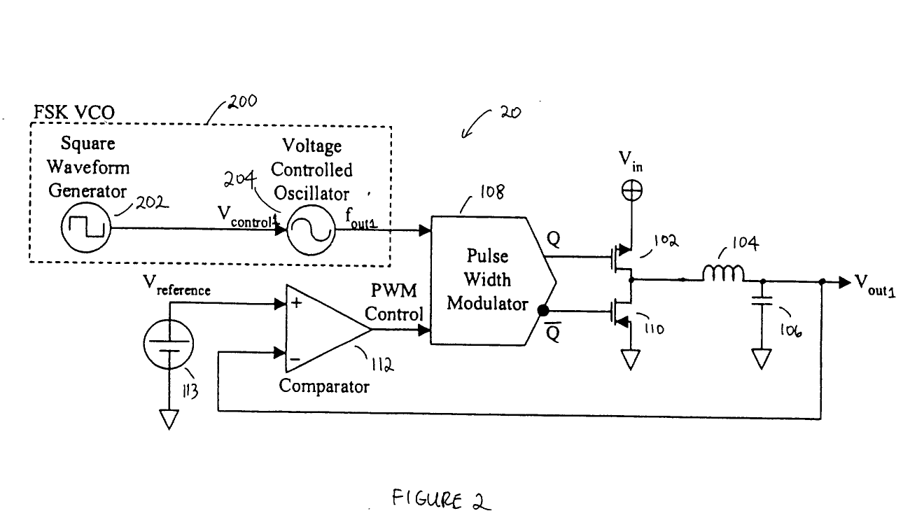

Referring now to FIG. 2, there is shown a power supply 20 having switching noise suppression capabilities, according to another embodiment of the present invention. This embodiment is similar to that shown in FIG. 1, except that frequency dithering is achieved using an FSK voltage controlled oscillator (VCO) 200, rather than an FSK oscillator 114. Unless otherwise noted, other than the elements comprising FSK VCO 200, the elements in FIG. 2 are substantially the same or similar to corresponding elements in FIG. 1. Accordingly, these elements are identified (i.e. labeled) with the same reference numbers as are corresponding elements in FIG. 1. FSK VCO 200 includes a square waveform generator 202 that provides a square wave control signal V_{control1} to an input of a VCO 204. VCO 204 responds to control signal V_{control1} by providing an oscillating signal f_{OUT1}, which has a frequency that is dependent upon the voltage level applied to its input. Because the voltage of the square wave control signal V_{control1} alternates between a high level and a low level, the frequency of oscillating signal f_{OUT} changes from a first frequency to a second frequency. PWM 108 responds to the different frequency signals by providing corresponding first and second square wave signals at PWM outputs Q and \overline{Q}. Similar to the embodiment described in FIG. 1, the first and second square wave signals at PWM outputs Q and \overline{Q} causes MOSFET switches 102 and 110 to switch at different rates. This frequency dithering operation of switching power supply 20 creates a lower average peak power per given bandwidth, so that power supply 20 more readily complies with noise limitation standards.

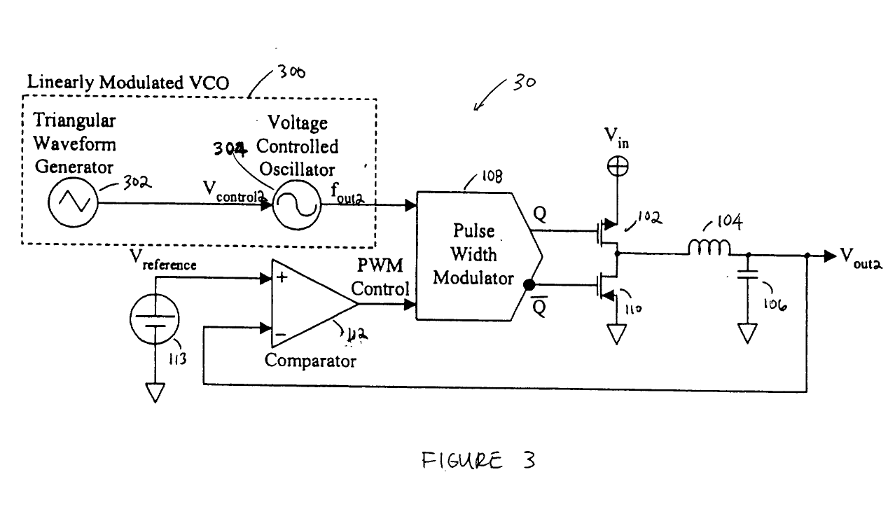

Other types of control signals, besides the square wave control signal V_{control1} provided by square waveform generator 202 may be applied to the VCO, to thereby generate different frequency dithering patterns. For example, in the embodiment in FIG. 3, power supply 30 utilizes a triangular wave control signal V_{control2} The power supply 30 shown in FIG. 3 is similar to the power supply shown in FIG. 2, except that frequency dithering is achieved using a linearly modulated VCO 300, rather than an FSK VCO 200. Other than the elements comprising linearly modulated VCO 300, the elements in FIG. 3 are substantially the same or similar to corresponding elements in FIG. 2. Accordingly, these elements are identified (i.e. labeled) with the same reference numbers as are corresponding elements in FIG. 2. Linearly modulated VCO 300 includes a triangular waveform generator 302 that provides a triangular wave control signal V_{control2} to an input of a VCO 304. VCO 304 responds to control signal V_{control2} by providing an oscillating signal f_{OUT2}, which has a frequency that is dependent upon the voltage level applied to its input. PWM 108 responds to oscillating signal f_{OUT2}, by providing frequency varying signals at PWM outputs Q and \overline{Q}. These frequency-varying signals cause MOSFET switches 102 and 110 to switch at various different rates, thereby creating a frequency dithering effect and a lower average peak power per given bandwidth, so that power supply 30 more readily complies with noise limitation standards.

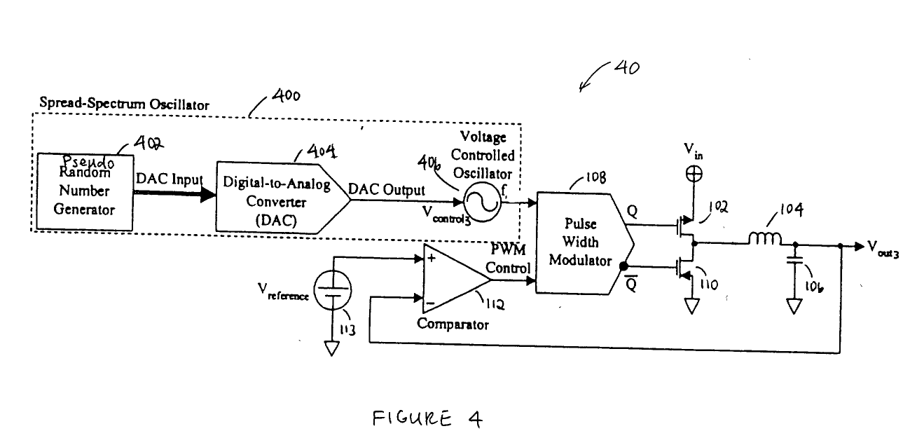

Referring now to FIG. 4, there is shown a power supply 40 having switching noise suppression capabilities, according to another embodiment of the present invention. The power supply 40 shown in FIG. 4 is similar to the other embodiments described above, except that frequency dithering is achieved using a spread-spectrum oscillator 400. Other than the elements comprising spread spectrum oscillator 400, the elements in FIG. 3 are substantially the same as in the previously described embodiments and are, therefore, labeled with the same reference numbers.

In power supply 40, a randomly variable frequency oscillator, i.e. spread-spectrum oscillator 400 is used to produce a pseudo-random frequency dithering pattern. Spread-spectrum oscillator 400 comprises a pseudorandom number generator 402 that produces a pseudorandom sequence of digital bits. The pseudo-random sequence of bits is input to a digital-to-analog converter (DAC) 404, which converts the digital bits to an analog control signal V_{control3} which has a voltage dependent upon the pattern of digital bits. Control signal V_{control3} is applied to a VCO 406 to produce a frequency dithering pattern that is essentially uniformly distributed over a given bandwidth, rather than being centered around a single switching frequency. In other words, the frequency dithering operation of this embodiment of the present invention creates a spread-spectrum switching power supply, which has the effect of transforming a narrow band signal with a large power spectral density to a broad-band signal with a lower power spectral density.

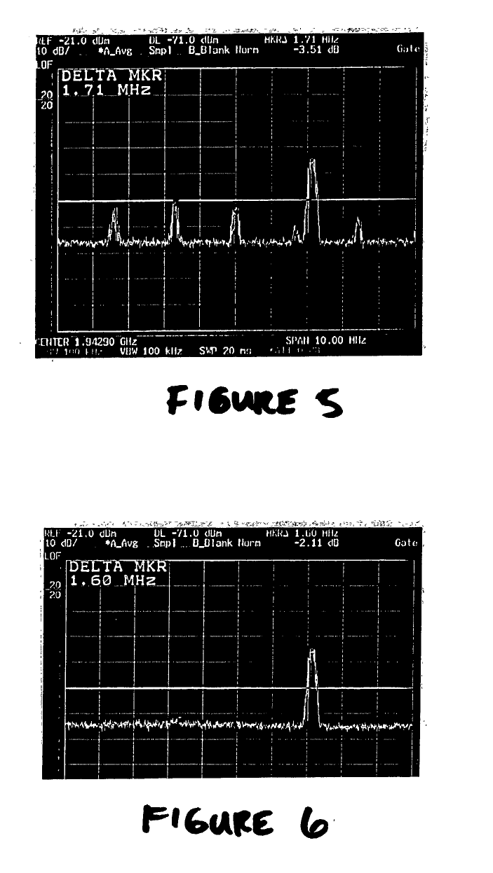

FIG. 5 shows a spectrum analyzer screen capture of a portion of a receiver band of a a receiver in a wireless communications system (specifically, a PCS communications system), while an associated transmitter is transmitting and is affected by the switching action of a nearby switching power supply. The large spur is a spur generated by the transmitter in the receive band and the other smaller spurs are unwanted spurs are attributable the switching of the power supply. They are “leaked” to the receive band by means of modulating the RF signals of the system.

FIG. 6 shows a spectrum analyzer screen capture of a portion of the receiver band of a receiver in the same wireless communications system described in association with the description of FIG. 5. However, the switching power supply includes a spread-spectrum oscillator, like the one described above in FIG. 4, for suppressing switching noise. The spectrum analyzer screen capture in FIG. 6 shows the effect of the frequency dithering of the power supply, i.e. the removal of the small spurs caused by the switching action of the power supply.

Whereas the above is a complete description of the preferred embodiments of the invention, various alternatives, modifications, and equivalents may be used. In particular, the various ways of controlling the voltage controlled oscillators described are intended to be exemplary and not exhaustive of other ways in which the VCOs may be controlled. Further, whereas the switching power supplies described are of the “buck” variety, there is no reason why the concepts of the present invention may not be applied to other types of switching power supplies, such as for example, “boost” power supplies. Therefore, the above description should not be taken as limiting the scope of the invention, which is defined by the appended claims.

What is claimed is:

1. A switching power supply having noise suppression capabilities, comprising:
a switching regulator having a direct current (DC) voltage input, an oscillator input and a regulator output;
a filter having a first end coupled to the output of the switching regulator and a second end providing an output for the power supply;
a variable-frequency oscillator coupled to the oscillator input of the switching regulator, said variable-frequency oscillator having a frequency control input and an output that provides a variable-frequency oscillating signal; and
an alternating waveform generator coupled to the frequency control input of the variable-frequency oscillator.

2. The switching power supply of claim 1 wherein the alternating waveform generator comprises a square waveform generator and the control signal is a square wave control signal.

3. The switching power supply of claim 1 wherein the alternating waveform generator comprises a triangular waveform generator and the control signal is a triangular wave control signal.

4. The switching power supply of claim 1 wherein the filter comprises:
an inductor having a first end coupled to the output of the switching regulator and a second end providing the output of the power supply; and
a capacitor having a first end coupled to the second end of the inductor and a second end coupled to ground.

5. The switching power supply of claim 1 wherein the switching regulator and the variable-frequency oscillator comprise an integrated circuit.

6. The switching power supply of claim 1 wherein the switching regulator comprises:
a pulse width modulator (PWM) having a PWM oscillating signal input configured to accept the variable-frequency oscillating signal, a PWM control input, a PWM output and an inverted PWM output;
a high-side switch having a first terminal coupled to the DC voltage input, a second terminal coupled to the regulator output and a control input coupled to the PWM output;
a low-side switch having a first terminal coupled to ground, a second terminal coupled to the regulator output and a control input coupled to the inverted PWM output; and
a comparator having an inverting input coupled to the power supply output, a non-inverting input coupled to a reference voltage and an output coupled to the PWM control input.

7. A switching power supply having noise suppression capabilities, comprising:
a switching regulator having a direct current (DC) voltage input, an oscillator input and a regulator output;
a filter having a first end coupled to the output of the switching regulator and a second end providing an output for the power supply;
a variable-frequency oscillator coupled to the oscillator input of the switching regulator, said variable-frequency oscillator having a frequency control input and an output that provides a variable-frequency oscillating signal;
a first resistor having a first end coupled to the frequency control input of the variable-frequency oscillator and a second end coupled to ground;
a second resistor having a first end coupled to the frequency control input of the variable-frequency oscillator and a second end;
a switching element having a first terminal coupled to the second end of the second resistor, a second terminal coupled to ground and a control terminal; and
an alternating waveform generator coupled to the control terminal of the switching element operable to cause the switching element to intermittently couple the second end of the second resistor to ground.

8. The switching power supply of claim 7 wherein the filter comprises:
an inductor having a first end coupled to the output of the switching regulator and a second end providing the output of the power supply; and
a capacitor having a first end coupled to the second end of the inductor and a second end coupled to ground.

9. The switching power supply of claim 7 wherein the switching regulator and the variable-frequency oscillator comprise an integrated circuit.

10. The switching power supply of claim 7 wherein the switching regulator comprises:
a pulse width modulator (PWM) having a PWM oscillating signal input configured to accept the variable-frequency oscillating signal, a PWM control input, a PWM output and an inverted PWM output;
a high-side switch having a first terminal coupled to the DC voltage input, a second terminal coupled to the regulator output and a control input coupled to the PWM output;
a low-side switch having a first terminal coupled to ground, a second terminal coupled to the regulator output and a control input coupled to the inverted PWM output; and
a comparator having an inverting input coupled to the power supply output, a non-inverting input coupled to a reference voltage and an output coupled to the PWM control input.

11. A switching power supply having noise suppression capabilities, comprising:
a switching regulator having a direct current (DC) voltage input, an oscillator input and an output;
a filter having a first end coupled to the output of the switching regulator and a second end providing an output for the power supply;
a variable-frequency oscillator coupled to the oscillator input of the switching regulator, said variable-frequency oscillator having a frequency control input and an output that provides a variable-frequency oscillating signal;
a pseudorandom number generator that provides a pseudorandom sequence of digital bits;
a digital-to-analog converter configured to accept the pseudorandom sequence of digital bits and provide a control signal having a variable voltage; and
a voltage controlled oscillator having a frequency control input configured to accept the control signal and an output that provides the variable-frequency oscillating signal.

12. The switching power supply of claim 11 wherein the filter comprises:
an inductor having a first end coupled to the output of the switching regulator and a second end providing the output of the power supply; and
a capacitor having a first end coupled to the second end of the inductor and a second end coupled to ground.

13. The switching power supply of claim 11 wherein the switching regulator and the variable-frequency oscillator comprise an integrated circuit.

14. The switching power supply of claim 11 wherein the switching regulator comprises:
a pulse width modulator (PWM) having a PWM oscillating signal input configured to accept the variable-frequency oscillating signal, a PWM control input, a PWM output and an inverted PWM output;
a high-side switch having a first terminal coupled to the DC voltage input, a second terminal coupled to the regulator output and a control input coupled to the PWM output;
a low-side switch having a first terminal coupled to ground, a second terminal coupled to the regulator output and a control input coupled to the inverted PWM output; and
a comparator having an inverting input coupled to the power supply output, a non-inverting input coupled to a reference voltage and an output coupled to the PWM control input.

15. A switching power supply having reduced switching noise, comprising:
switching regulator means for converting a direct current (DC) input voltage to an DC output voltage; and
a variable-frequency oscillating means coupled to the switching regulator means for varying a rate at which the regulator means switches when the DC input voltage is being converted to the DC output voltage.

16. The switching power supply of claim 15 wherein the variable-frequency oscillating means comprises a voltage controlled operator means for providing an oscillating signal having a frequency dependent upon the voltage of a control signal.

17. The switching power supply of claim 16 wherein the control signal comprises a digital-to-analog converted pseudorandom sequence of digital bits.

18. The switching power supply of claim 16 wherein the variable-frequency oscillating means further comprises an alternating waveform generator means.

19. A method of reducing noise in a switching power supply, comprising the steps of:
converting a direct current (DC) input voltage to a DC output voltage using a switching power supply;
varying the rate at which the switching power supply switches during the step of converting.

20. The method of claim 19 wherein the step of varying comprises a step of varying a voltage level of a control signal at a control input of a voltage controlled oscillator (VCO) to provide a pulse width modulator oscillating signal determinative of the rate of switching.

21. The method of claim 20 wherein the step of varying the voltage level of the VCO comprises providing a digital-to-analog converted sequence of pseudorandom bits to the control input of the VCO.

22. The method of claim 20 wherein the step of varying the voltage level of the VCO comprises providing an alternating voltage signal to the control input of the VCO.
